(19) United States
(12) Patent Application Publication
(10) Pub. No.: US 2003/0028130 A1
(43) Pub. Date: Feb. 6, 2003

(54) Machine for upper limb physical therapy

(76) Inventors: Craig Wunderly, Hackettstown, NJ (US); Aman Siffeti, Livingston, NJ (US); Christopher Hardy, Montclair, NJ (US); Matthew S. Colello, Tranquility, NJ (US); Richard M. Mahoney, Westmont, NJ (US); Daniel Zuckerman, Bloomfield, NJ (US)

Correspondence Address: Richard M. Mahoney, Rehabilitation Technologies Division, Applied Resources Corp., 1275 Bloomfield Ave., Fairfield, NJ, 07004, US

(21) Appl. No.: 10/212,607

(22) Filed: Aug. 5, 2002

Related U.S. Application Data
(60) Provisional application No. 60/310,107, filed on Aug. 4, 2001.

(51) Int. Cl. A61H 1/02; A63B 24/00; A63B 71/00

(52) U.S. Cl. 601/5; 601/26; 601/33; 482/4; 482/903

(57) ABSTRACT

This invention relates to an electromechanical arm and accessories which are mountable on a battery powered wheelchair and used to grasp objects in the personal environment of the operator. The device is designed for simplicity of operation and comprises lower arm, mid arm, and forearm components which are rotationally and pivotally interconnected and selectively rotated through the utilization of a controller which is preferably disposed upon the battery powered wheelchair. The accessories include end-effectors (also called grippers), with features that are task specific or for general manipulation, other tools and means of holding tools, baskets, pouches, holders and other means of storing objects and tools, a variety of input devices that are tailored to the needs of the operator, a sleeve for protection, aesthetics, and increased functionality (with pockets and other means of holding objects), and mounting hardware for the electromechanical arm and associated components.

### RELATED APPLICATIONS

The present application is related to and claims priority from U.S. Provisional Patent Application 60/310,107 filed Aug. 4, 2001.

### STATEMENT REGARDING FEDERALLY SPONSORED RESEARCH OR DEVELOPMENT

This invention was made with U.S. Government support under Grant Numbers, HD41287-01, awarded by the National Institutes of Health. The government has certain rights in the invention.

### CROSS REFERENCE TO RELATED APPLICATIONS

| U.S. Pat. No. | Inventor | Award Date |
|---|---|---|
| 5,830,160 | Reinkensmeyer | Nov. 3, 1998 |
| 5,466,213 | Hogan, et al. | Nov. 14, 1995 |
| 4,936,299 | Erlandson | Jun. 26, 1990 |

### BACKGROUND OF THE INVENTION

People who have experienced a severe stroke often have significant impairment of muscle function of the arms, legs, and hands, resulting in severe disability. Other types of diseases, traumatic accidents, and neurological disorders result in similar deficiencies in strength, coordination, and range of motion. In order to recover or retain functional ability after a stroke or injury, people normally enter into a rehabilitation program at a rehabilitation facility, under the treatment of a physical and/or occupational therapist. Although the invention described here applies to all rehabilitation programs of this type for upper limb therapy, it is described in terms of its applicability to stroke patients because stroke is the number one disability for which rehabilitation services are provided in the United States.

For upper limb rehabilitation, the nature of the disability requires that the Therapist carry out a program whereby he or she will move the patient's arms through a range of motion that is comfortable to the patient as appropriate given the level of recovery of their strength and coordination. Typical therapy programs administered by a Therapist can also involve functional tasks and movements using one or both arms. As the patient's functional ability increases, the Therapist modifies the regiment to provide less assistance, to extend the range of motion, and to increase the types and difficulty of functional tasks. Such a rehabilitation program requires that the Therapist assess the physical ability of the person on an ongoing basis.

In a rehabilitation program taking place directly after the stroke has occurred, the amount of therapy a person receives is directly related to the severity of the stroke, the region of the brain in which it occurred, the quality and speed of treatment directly following the stroke, and the actual amount of recovery of ability. For these reasons, the assessment by the Therapist, and the ability to alter the range of motion and assistance provided is critical to treating each individual. It is a paradox of the current medical healthcare environment that, increasingly, the amount of therapy a person receives is being limited by the number of sessions for which a reimbursement will be made and not necessarily on the level of recovery that has been achieved.

It is an objective of the present invention to provide a device that may be used as a tool by a therapist whereby the therapist can assess the recovery of the patient, and then utilize the present invention to assist the patient with the repetitive motions of the therapy. In this scenario, one therapist can work with a multitude of patients all utilizing the present invention to facilitate movement of the arms through the normal ranges of motions. The present invention utilizes robotic technology, including force and position sensors, to measure the interaction of the patient with the device and to modify the amount of assistance, or resistance, according to the measured information, similar to the actions of a Therapist in a typical rehabilitation program.

There are generally four other devices that have been developed in the context of research projects, or modest commercialization efforts, that also make use of robotics technology to facilitate stroke rehabilitation.

MIME, Machiel Van der Loos, Peter Lum, Chuck Burgar, VA Rehabilitation R&D Center, Palo Alto, Calif. MIME is an experimental test rig that provides bi-manual therapy according to four control modes. The concept for the present invention and the motions of the device described herein are based on the four control modes first developed for MIME. The MIME system is an experimental test rig using a commercial robot and a six degree of freedom digitizer to perform the therapeutic activity, and thus it requires a complex controller and control software and is excessively expensive to be practical as a product. The mechanical system is also large and although many safety features have been built into the system, its appearance is sometimes uncomfortable for both the patients and the operators.

The following references provide further information about the MIME device:

Lum P S, Burgar C G, Kenney D, Van der Loos H F M. Quantification of force abnormalities during passive and active-assisted upper-limb reaching movements in post-stroke hemiparesis. IEEE Transactions Biomedical Engineering 46(6):652-62, 1999.

Lum P S, Van der Loos H F M, Shor P, Burgar C G. A robotic system for upper-limb exercises to promote recovery of motor function following stroke. Proceedings, 6^{th} International Conference on Rehabilitation Robotics ICORR′99;Jul. 1-2, 1999 Stanford, Calif. p. 235-9.

Burgar C G, Lum P S, Shor M, Van der Loos H F M. Rehabilitation of upper limb dysfunction in chronic hemiplegia: Robot-assisted movements vs. conventional therapy. Arch Phys Med Rehabil 80(9) :1121, 1999.

ARM Guide, David Reinkensmeyer, Department of Mechanical Engineering, University of California at Irvine, and the Rehabilitation Institute of Chicago. The ARM Guide is a one degree of freedom electromechanical system that supports single arm movement for the purpose of stroke therapy. The ARM Guide, however, cannot be used for bi-manual therapy as a single degree of freedom system.

The following references provide further information about the ARM Guide device:

Reinkensmeyer; David J., Movement guiding system for quantifying diagnosing and treating impaired movement performance. U.S. Pat. No. 5,830,160, Nov. 3, 1998.

MIT-Manus, Neville Hogan, Department of Mechanical Engineering, MIT. MIT Manus is a robot that provides upper limb therapy in a plane. This system is based on a particular force control algorithm and uses video games to facilitate interaction of the patient with the therapy. This system, however, is not a single degree of freedom device, and cannot be used to carry out bi-manual therapy as such.

The following references provide further information about the MIT-Manus device:

Hogan, et al., Interactive robotic therapist. U.S. Pat. No. 5,466,213, Nov. 14, 1995.

Therapy Robot, Bob Erlandson, Wayne State University, This system consists of a light industrial robot that moves a target to different positions in front of a patient. The patient receives therapy through the activity of reaching out and touching the target as it is moved to different locations by the robotic device. This system, however, cannot support the weight of the patient, it is not a single degree of freedom device, and cannot be used for bi-manual therapy as such.

The following references provide further information about the Therapy Robot device:

Erlandson; Robert F., Method and apparatus for rehabilitation of disabled patients. U.S. Pat. No. 4,936,299, Jun. 26, 1990.

### BRIEF SUMMARY OF THE INVENTION

This invention is a device to carry out stroke therapy ranges of motion on a human user, including both actively assisting the motion of the user or actively resisting the motion of the user. It is differentiated from other devices in this field because it combines the following characteristics in one device:

1. Bi-manual operation: This device is designed to accommodate support of both arms and to provide a device to facilitate therapy programs that make use of force and position information from both arms. This is not exclusive, however. The novelty is that the device can be used for single arm therapy as well as dual arm therapy.

2. Single degree of freedom system: The present invention requires a single drive shaft which engages the motor, brake, position sensor, and drive system which operates the bi-manual motion of the device. This single degree of freedom approach significantly simplifies the cost, manufacture, and control of the system.

3. Detailed mechanical design elements and configuration: The present invention may be adjusted so that the arms are moved through a multitude of directions. The ability to manually and rigidly reconfigure the vector of the arm motion is a unique aspect of this device.

4. Movement out of a horizontal plane: The present invention permits movement of the arm out of a horizontal plane. The arms may be guided to move up or down at various angles of elevation and rotation from the patient.

5. Range of modes: The present invention may operate in several modes including, carrying the limb or limbs through a range of motion with no assistance from the patient (referred to as passive mode), moving the limb through a range of motion after sensing a correct movement intention of the patient, adjusting the amount of assistance to the patient while moving the limb or limbs through a range of motion with the amount of assistance based on the strength of the motion contributed by the patient, and resisting the movement of the patient along the movement direction in order to provide resistance training for the patient.

6. Adapting and responding to individual patient ability levels: The modes as described above are all facilitated through the use of sensor information, namely force measurements at the location where the arm rests on each of the guides, and the position of the guide along the track as measured by the rotation of the single drive shaft. The force and position information is used to determine the appropriate range of motion, number of repetitions, and force and safety thresholds.

7. Replication of therapy motions: The mechanical and software elements of the system allow it to be used to replicate the ranges of motion and application of forces applied by a physical therapist during rehabilitation therapy carried out after a stroke.

8. Provides quantitative data: The present invention consists of force and position sensors, which provide an objective, means of measuring quantitatively the range of motion, force application, force profile, and other indicators of the limbs' performances. This capability has the potential to provide a new standard whereby therapists and physicians can communicate about the status of an individual's disability through new quantitative data.

It is envisaged that this device may be utilized in the clinic under several scenarios:

1. One physical therapist monitoring several patients at one time using multiple devices.

2. Independent use in a clinic by a patient to extend the amount of therapy time for that patient.

3. Physical therapist assumes the role of managing the rehabilitation through program of device use and monitoring of measured and derived values.

### BRIEF DESCRIPTION OF THE SEVERAL VIEWS OF THE DRAWINGS

These as well as other features of the present invention will become more apparent upon reference to the drawings wherein:

FIG. 1 is a perspective view of the preferred embodiment of the machine for upper limb physical therapy, showing all components of the present invention;

FIG. 2 is a perspective view of the support structure components comprising the machine for upper limb physical therapy of the present invention;

FIG. 3 is a perspective view of the slide arm assembly Number 1 comprising the machine for upper limb physical therapy of the present invention;

FIG. 4 is a perspective view of the slide arm assembly Number 2 comprising the machine for upper limb physical therapy of the present invention;

FIG. 5 is a perspective view of the cross member assembly comprising the machine for upper limb physical therapy of the present invention;

FIG. 6 is a perspective view of sliding platform Number 1 comprising the machine for upper limb physical therapy of the present invention;

FIG. 7 is a perspective view of sliding platform Number 2 comprising the machine for upper limb physical therapy of the present invention;

FIG. 8 is a plan view of the motor clutch assembly comprising the machine for upper limb physical therapy of the present invention;

FIG. 9 is a cross section view of the motor clutch assembly comprising the machine for upper limb physical therapy of the present invention;

FIG. 10 is a perspective view of the drive system comprising the machine for upper limb physical therapy of the present invention;

FIG. 11 is two perspective views of the support structure components in various positions comprising the machine for upper limb physical therapy of the present invention;

FIG. 12 is a block diagram of the preferred embodiment of the control system and sensing elements comprising the machine for upper limb physical therapy of the present invention;

FIG. 13 is a block diagram of the control modes for the control system and sensing elements comprising the machine for upper limb physical therapy of the present invention;

### DETAILED DESCRIPTION OF THE PREFERRED EMBODIMENT

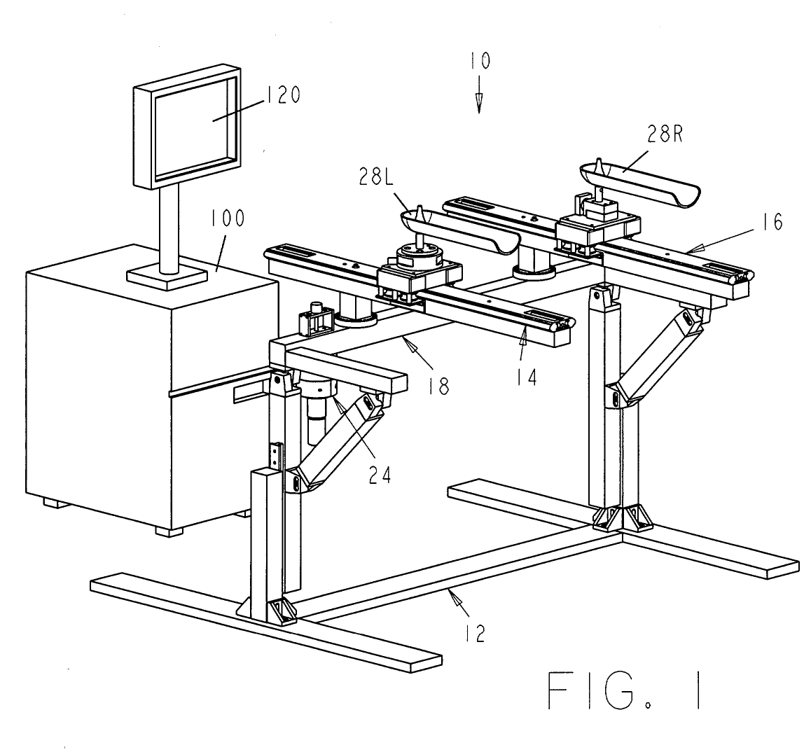

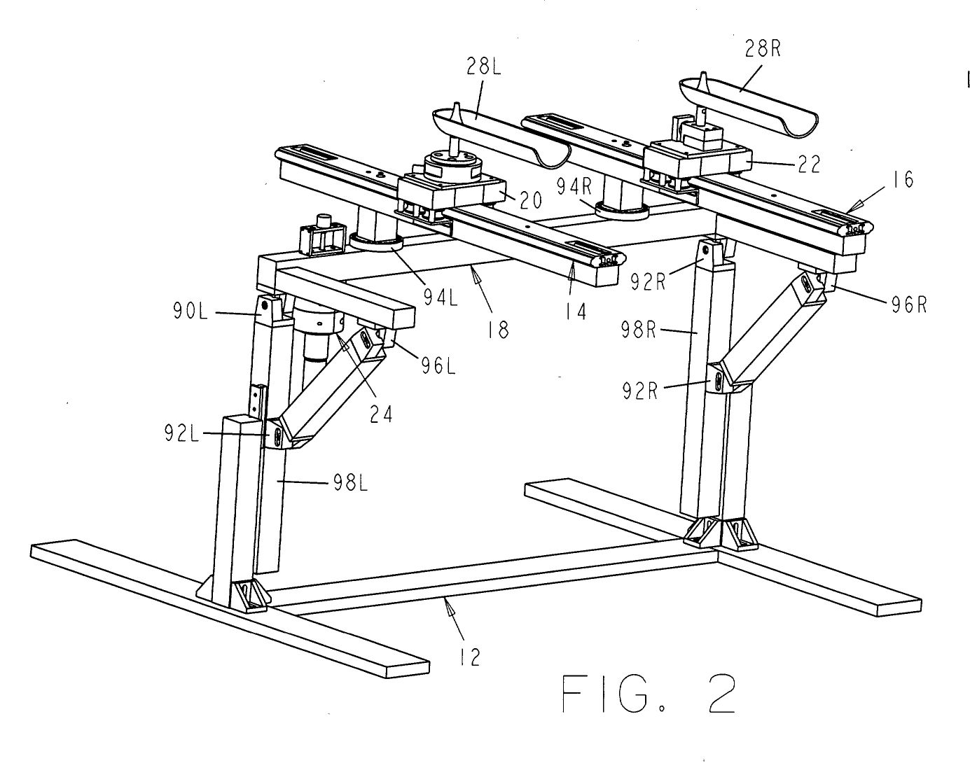

Referring now to the drawings wherein the showings are for purposes of illustrating a preferred embodiment of the present invention only, and not for purposes of limiting the same, FIG. 1 perspectively illustrates the machine for upper limb physical therapy 10 constructed in accordance with the preferred embodiment of the present invention. Referring now to FIGS. 1 and 2, the machine for upper limb physical therapy 10 generally comprises a control system 100 with display interface 120; and support structure components comprising of Dual arm support assemblies 14 and 16, cross member assembly 18, support structure 12, drive system 24 and user interfaces 28L and 28R.

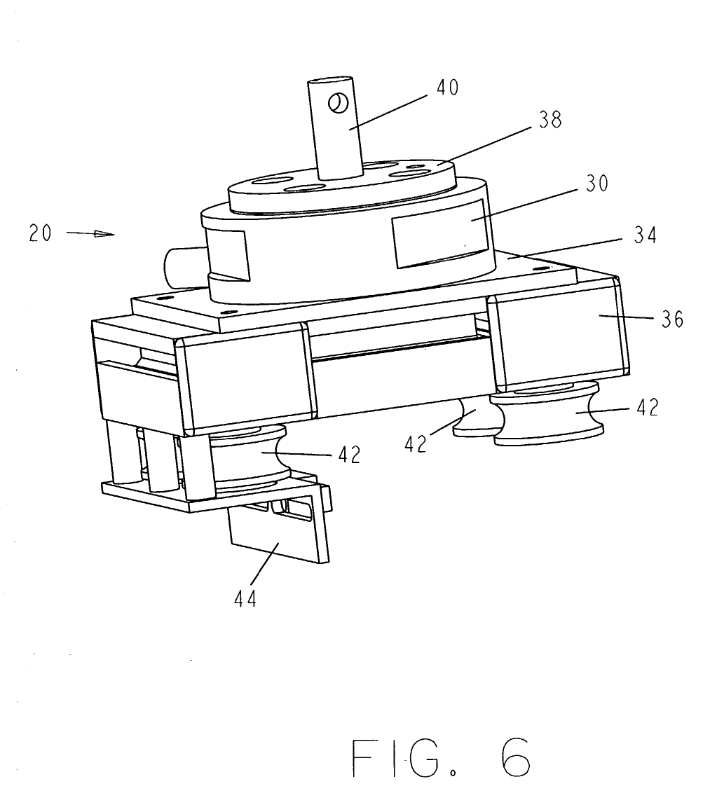

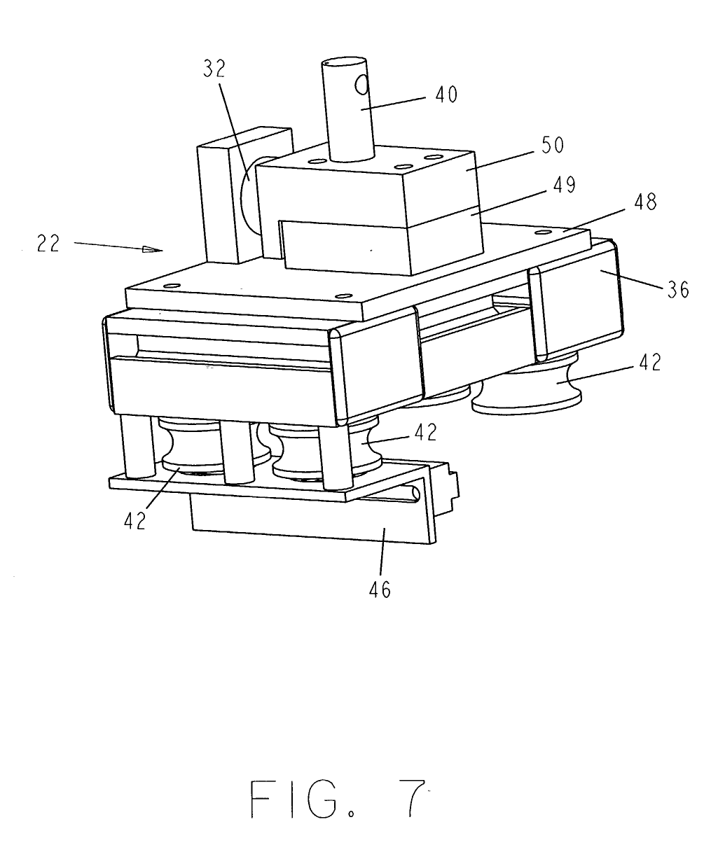

Referring now to FIGS. 2, 3 and 4 the dual arm support assemblies 14 and 16 each includes a linear track 86 and 88 respectively that hold sliding platforms 20 and 22 respectively. The sliding platforms 20 and 22 have means for connecting braces 28L and 28R that can hold the arms of a user firmly. The sliding platforms 20 and 22 are capable of sliding movement along the linear tracks 86 and 88 through intimate contact of the rollers 42, thereby carrying the user interface braces 28L and 28R along a linear path. Referring now to FIGS. 6 and 7 the sliding platforms 20 and 22 each have a carriage 36 which provides structural support for the rollers 42, a provision for easily mounting either mounting plate 34 or mounting plate 48. The carriage 36 also has means for attaching to the drive system 24 through brackets 44 and 46 which are securely attached to carriage 36 and operatively attached to the drive system 24 through drive system attachment blocks 74 and 76.

Mounting plate 34 is used for attaching force sensor 30, which measures three orthogonal components of force and three orthogonal components of torque. Either of the user interface braces 28L or 28R is mounted to force sensor 30 through a quick connect ball joint 40 which is operatively attached to force sensor 30 by means of mounting plate 38. The force sensor 30 measures the forces exerted by the user's impaired arm on the system. In addition, mounting plate 48 is used for attaching force sensor 32, which measures one component of force in the direction of linear movement of sliding platforms 20 and 22 and in turn the forces exerted by the user's unimpaired arm on the system. Either of the user interface braces 28L or 28R is mounted to the input side of force sensor 32 through quick connect ball joint 40 which is attached to mounting block 50. Mounting block 50 is operatively coupled to force sensor 32 and linear bearing 49, which only allows sliding movement in the direction of the measurement force of force sensor 32. Linear bearing 49 is also firmly attached to mounting plate 48.

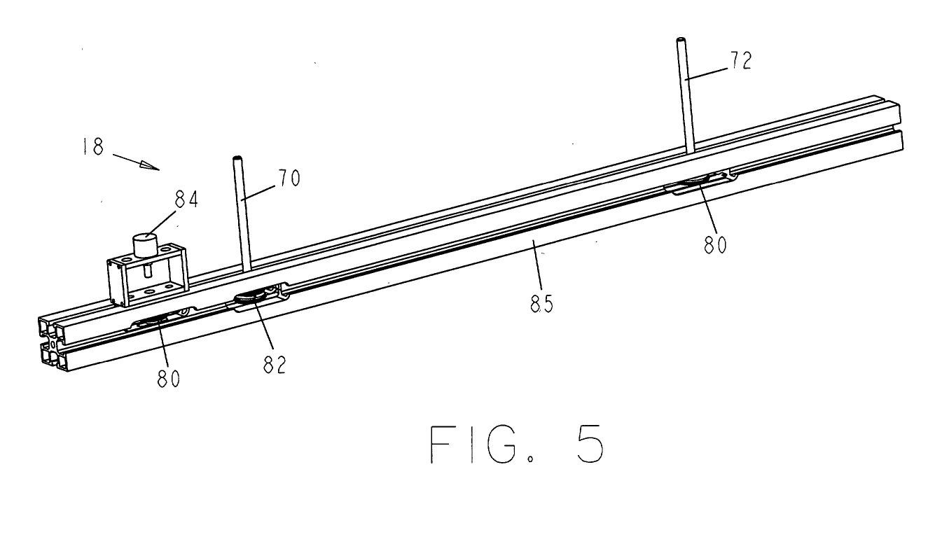

Referring now to FIGS. 2 and 5 support base 12 provides a structure that holds the dual arm supports 14 and 16. Support base 12 rests on the ground and in the preferred embodiment, dual arm support assemblies 14 and 16 are connected to cross member assembly 18 through the attachment of the yaw rotation plates 94L and 94R. By loosening the yaw rotation plates 94L and 94R the dual arm support assemblies 14 and 16 are selectively articulable in the yaw direction to angled orientations of approximately 0 degrees to 345 degrees. Cross member assembly 18 is pivotally connected to the support base 12 at the pivot joints 90L and 90R. Cross member assembly 18 is also pivotally and linearly attached at 92L and 92R as well as 96L and 96R.

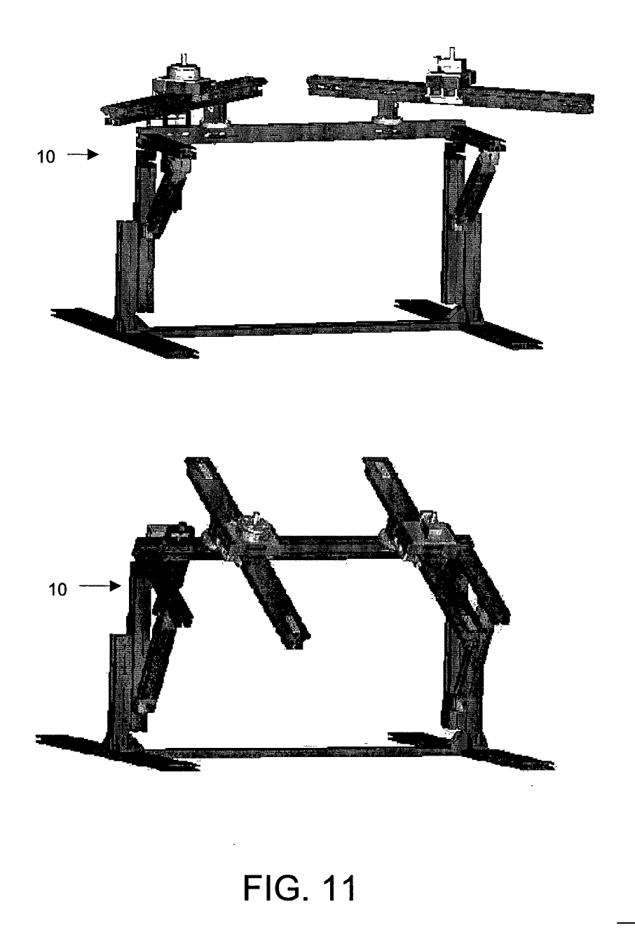

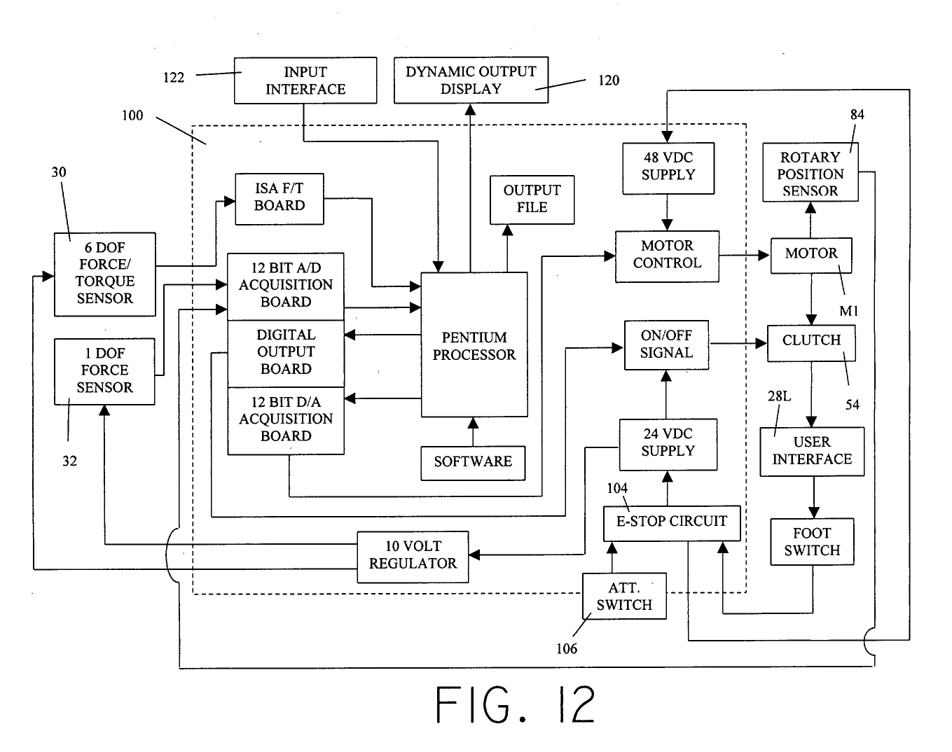

As will be recognized, since cross member assembly 18 serves to directly interface dual arm support assemblies 14 and 16 to support base 12, the rotation of cross member assembly 18 will cause the concurrent rotation of the dual arm support assemblies 14 and 16. By loosening the pivot joints 90L, 90R, 92L, 92R, 96L and 96R the dual arm support assemblies 14 and 16 are selectively articulable in the pitch direction to angled orientations of approximately 0 degrees to 170 degrees. Referring to FIG. 11, two possible configurable positions that the dual arm support assemblies 14 and 16 can be manually reconfigured may be seen. Referring again to FIG. 2, the support members 98L and 98R have a sliding connection between support base 12 and support members 98L and 98R. By loosening the sliding joints of support members 98L and 98R the dual arm support assemblies 14 and 16 can also be manually reconfigured to change the height of the plane in which they sit.

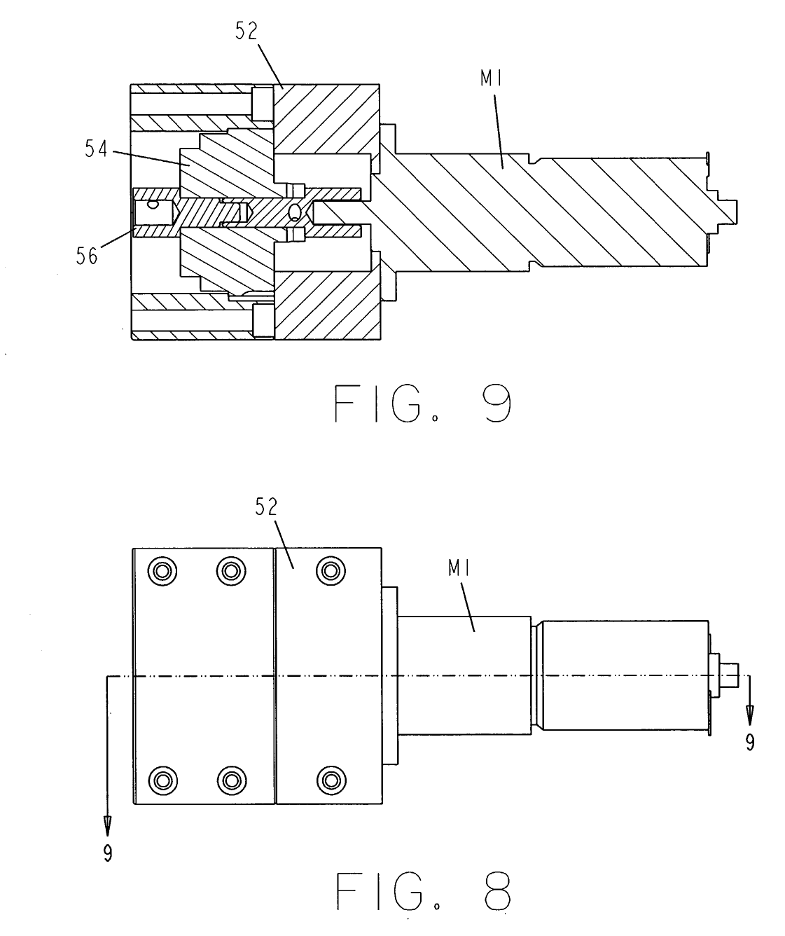

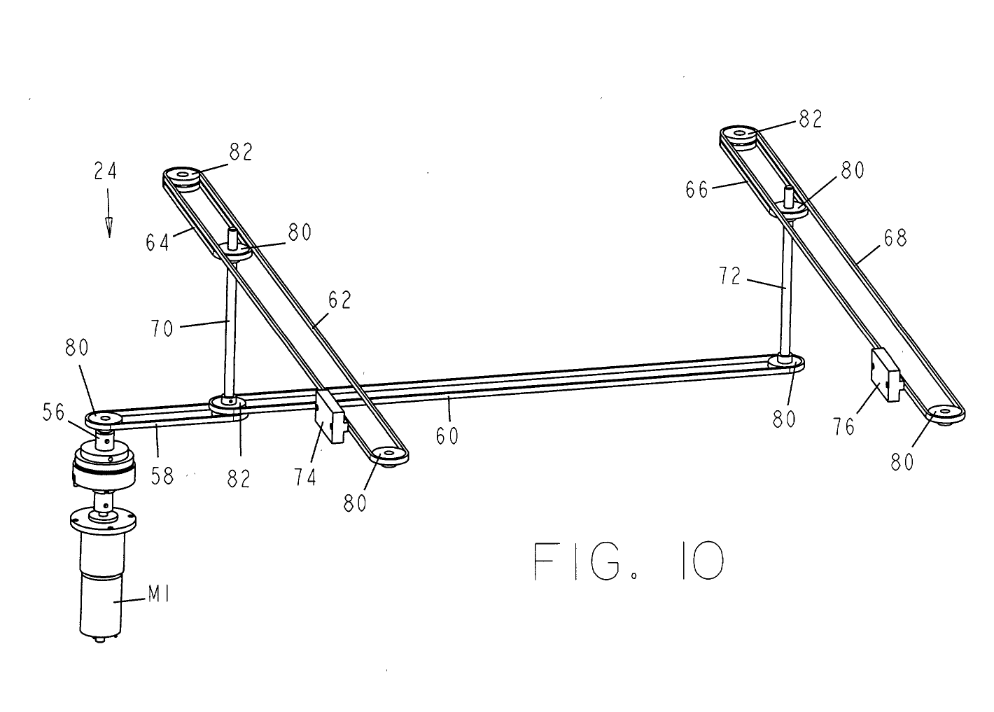

Referring now to FIGS. 8, 9 and 10 the sliding platforms 20 and 22 are driven in a linear movement by means of a motor M1 via a crown-toothed electric clutch 54 and drive system 24. The motor M1 and crown-toothed electric clutch 54 are connected to the cross member assembly 18 via motor mounting block 52. Drive system 24 includes a series of drive shafts 56, 70 and 72; chains 58, 60, 62, 64, 66, and 68; and sprockets 80 and 82 connected as follows. The output drive shaft of the motor M1 is operatively connected to the crown-toothed electric clutch 54, and the crown-toothed electric clutch 54 will in turn rotate the drive shaft 56 as long as the load resistance torque on the drive shaft 56 does not exceed 50 inch-pounds. A load resistance torque greater than 50 inch-pounds will cause the crown-toothed electric clutch 54 and drive shaft 56 to slip causing the sliding platforms 20 and 22 to move freely with no resistance along the linear tracks 86 and 88.

As shown in FIG. 10 a single sprocket 80 is operatively coupled to drive shaft 56. Drive shaft 56 extends through the cross member 85 and is also operatively attached to the input shaft of potentiometer 84. The body of potentiometer 84 is fixed to cross member 85. The potentiometer 84 changes resistance as drive shaft 56 is rotated. The position of the sliding platforms 20 and 22 along the linear tracks 86 and 88 can be measured by monitoring the change in resistance of potentiometer 84.

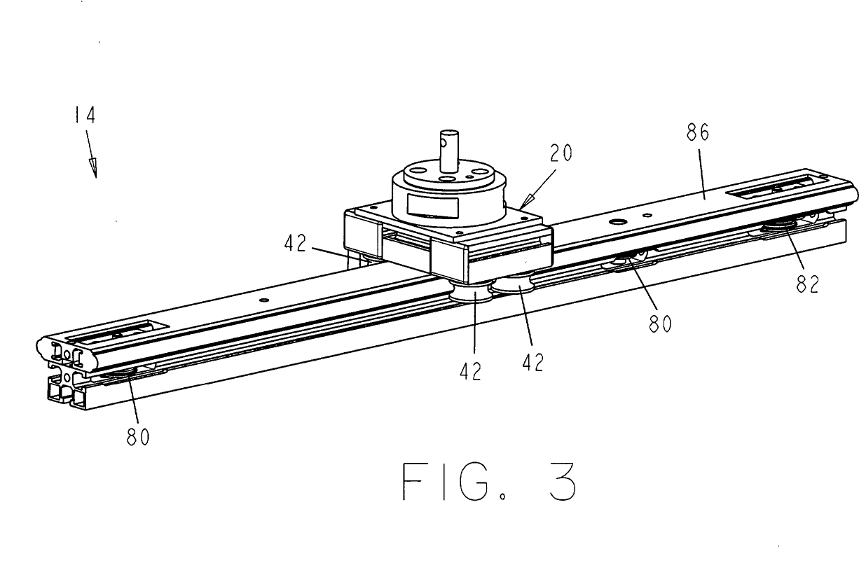

Referring now to FIGS. 3, 5 and 10 the single sprocket 80 on drive shaft 56 drives chain 58, which in turn drives dual sprocket 82 on the end of drive shaft 70. Drive shaft 70 extends through the cross member 85 and linear track 86, and is also operatively attached to another sprocket 80 on the opposite end of drive shaft 70. The single sprocket 80 on the opposite end of drive shaft 70 drives chain 64, which in turn drives another dual sprocket 82 which is mounted internally to linear track 86. The dual sprocket 82 which is mounted internally to linear track 86 drives chain 62 which is attached to sliding platform 20 via drive system attachment block 74.

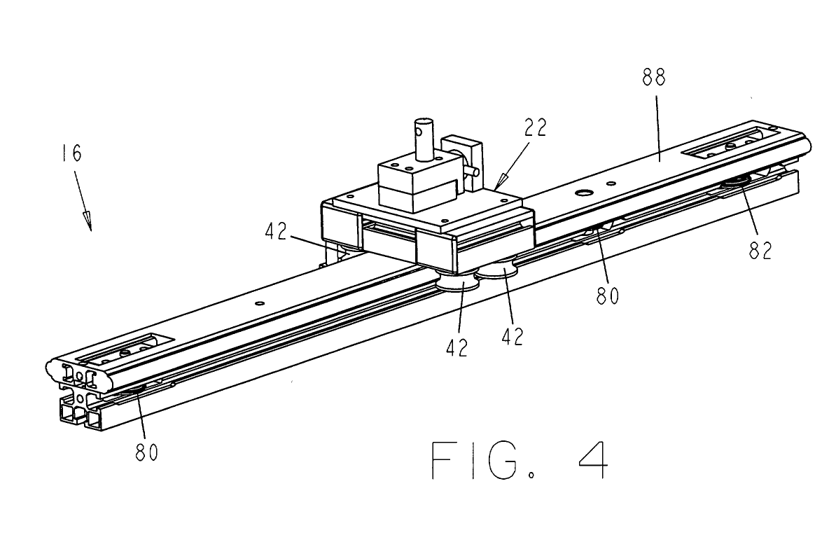

Referring now to FIGS. 4, 5 and 10 The dual sprocket 82 on the end of drive shaft 70 also drives chain 60 which drives another sprocket 80 on the end of drive shaft 72. Drive shaft 72 extends through the cross member 85 and linear track 88, and is also operatively attached to another sprocket 80 on the opposite end of drive shaft 72. The single sprocket 80 on the opposite end of drive shaft 72 drives chain 66, which in turn drives another dual sprocket 82 which is mounted internally to linear track 88. The dual sprocket 82 which is mounted internally to linear track 88 drives chain 68 which is attached to sliding platform 22 via drive system attachment block 76.

As will be recognized, since the sliding platforms 20 and 22 on the linear tracks 86 and 88 respectively, are each connected to drive system 24, and all of the sprockets in drive system 24 are of the same diameter, the relative motion between sliding platforms 20 and 22 will be fixed. Each sliding platform 20 and 22 is constrained to move at the same time in the same direction along the linear tracks 86 and 88, either towards or away from the user.

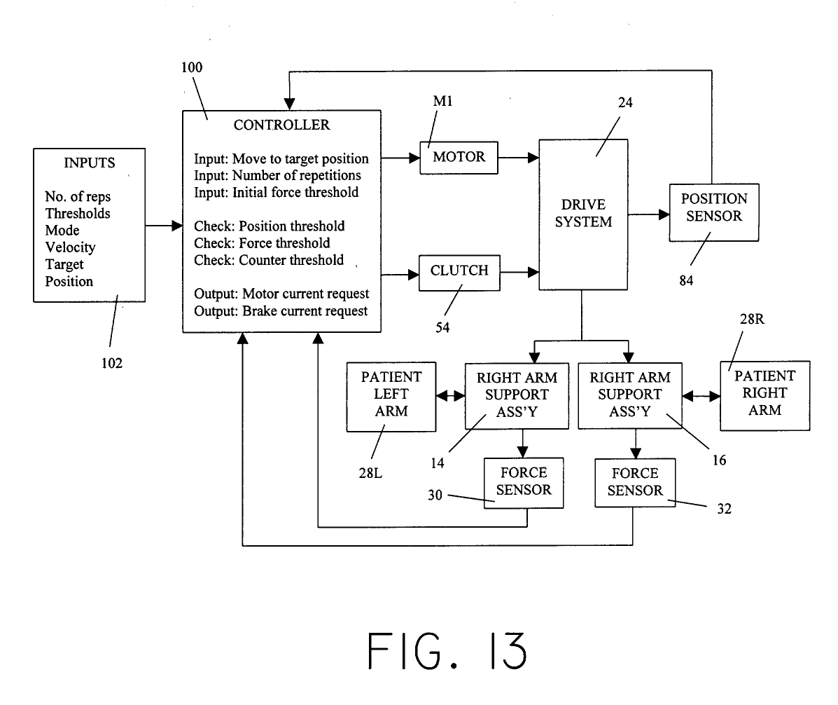

Referring now to FIG. 12 the machine for upper limb physical therapy 10 generally comprises a control system 100 with display interface 120 and input interface 122 used to control the dual arm support assemblies 14 and 16 through user interfaces 28L and 28R.

Referring now to FIGS. 12 and 13, the present invention is able to operate in several control modes that define the interaction with the patient that occurs at the patient inputs 28R and 28L. The device receives inputs 102 that define the range of motion, number of repetitions of movement, force thresholds, and mode of operation into controller 100. The controller monitors the output sensor information from position sensor 84 and force sensors 30 and 32 and determines the output signals to motor M1 and clutch 54.

Referring still to FIG. 13, operation of the present invention occurs as follows for each control mode. In passive mode, the input 102 includes a target movement distance, a movement velocity, a force safety threshold, and a number of repetitions of movement. Upon initiation of the program, the invention will move the patient's arm at 28R or 28L along the dual arm support assemblies 14 and 16 from the starting location to the target distance and back to the starting location a number of times equal to the input 102 for the number of repetitions. The controller will monitor the force sensor info from 30 and 32 and will provide an output request for the motor M1 to move at the target speed until the position target is reached, and stop motion of the system if the safety threshold for these force values are exceeded. The user may assist during this motion, but the purpose of this mode is to provide range of motion exercising for the patient without any active use of the muscle.

Again referring to FIG. 13, in active-assisted mode, the input 102 includes a target movement distance, a movement velocity, an active force threshold, a force safety threshold, and a number of repetitions of movement. Upon initiation of the program, the controller will monitor the force sensor 30 at the patient interface 28R or 28L and compares the force generated in the direction of motion along the dual arm support assemblies 14 and 16 with the active force threshold. When the force in the direction of motion exceeds the active force threshold, the controller initiates outputs to the motor M1 to initiate movement of the left arm support assembly 14 and/or Right arm support assembly 16 and after motion occurs, the controller 100 monitors the device as if it were operating in the passive mode as described above until the Left arm support assembly 14 and/or Right arm support assembly 16 returns to the starting location. For the next repetition, the controller 100 again monitors the force in the direction of motion and initiates motion when this force exceeds the active force threshold. This sequence continues until the controller 100 identifies that the target number of repetitions has been achieved. During the motion of the dual arm support assemblies 14 and 16, the user may actively support the movement, but the movement forces are not used by the controller 100 in determining the output to motor M1. If a force exerted at 28R or 28L exceeds the safety force threshold, then the controller 100 will provide an output to the clutch 54 that will disengage the system from the user. The purpose of the active-assisted mode is for the patient to practice correctly initiating a movement in the direction of motion.

Referring still to FIG. 13, in active-constrained mode, the input 102 includes a target movement distance, a movement velocity, an active force resistance, a force safety threshold, and a number of repetitions of movement. Upon initiation of the program, the patient will actively engage the left arm support assembly 14 or right arm support assembly 16 at the patient interface 28R or 28L and will move the users arm along the arm support assemblies 14 and 16. The controller will monitor the force sensor 30 at the patient interface 28R or 28L and compare the force generated in the direction of motion along the dual arm support assemblies 14 and/or 16 with the active force resistance. The controller 100 will provide an output request to the motor M1 to oppose the motion of the users arm and thus create a resistance force at the Patient Interfaces 28R or 28L. The resistance force will be low enough so that the patient may overcome it and thus a form of resistance strength training will take place. If the force in the direction of motion exceeds the active resistance force, the controller 100 initiates outputs to the motor M1 to reduce the opposing motion. When the dual arm support assemblies 14 or 16 reach the target distance provided by input 102, the patient will return the sliding platform 20 or 22 to the starting point and the controller 100 will monitor the force at the patient interface 28R or 28L and will provide outputs to the motor M1 to resist this motion until the active resistance force is achieved. This sequence continues until the controller identifies that the target number of repetitions has been achieved. If a force exerted at 28R or 28L exceeds the safety force threshold, then the controller 100 will provide an output to the clutch 54 that will disengage the system from the user. The purpose of this mode is to provide the patient with the opportunity to practice resistance strength training.

We claim:

1. An electromechanical articulated arm, specifically for attaching to an existing powered wheelchair,

2. Item of claim 1, that may be controlled by an operator who is mobility and manipulation-impaired using a range of input devices, including an eight-position slotted binary joystick, a sip and puff device, a 10-key keypad, a series of switches, or by any other means suitable for the operator.

3. Item of claim 1, with a controller that can adapt interchangeably to the range of input devices as listed in claim 2.

4. Item of claim 1 with brakes integrated into the joints to hold the joint in place against the force of gravity of the structure of the item and objects being held or moved by the end-effector of the item, when the item is not in motion.

5. Item of claim 1 with configuration that is suitable for mounting on different locations of an existing powered wheelchair.

6. Item of claim 1 with a remote on/off switch separate from the on/off switch on the controller, that can be mounted near to the operator.

7. Item of claim 1 with slip clutches integrated into the joints and preventing force being exerted by any member beyond the specified torque limit,

8. Item of claim 2 with a range of end-effectors, including dual pincing gripper, a pointer, or other means of picking up and moving objects,

9. Item of claim 7 with a set of external tools that may be picked up by the end-effector and used for specific purposes, such as a pointer holder, straps for opening drawers and doors, adapted utensils for eating, and other like items.

10. Item of claim 2 with a removable textile sleeve.

11. Item of claim 9 possessing other characteristics such as pockets, a watch, or other features that extend the functionality and utility,

12. Item of claim 9 that is cushioned for safety and protection,

13. Item of claim 1 with a quick release mechanism whereby the electromechanical arm can be removed and securely refastened conveniently for storage or alternate transport,

14. Item of claim 3 which is electronically gated so that only one motion of the electromechanical arm may be possible at one time,

15. Item of claim 3 with circuitry to limit the acceleration of each joint according to a trapezoidal velocity profile,

16. Item of claim 3 with a power saving sleep mode that is entered after 100 milliseconds, or some other period of time which is adjustable, whereby the current drain diminishes to 30 milliamps, or some other current level that may be set, decreasing the overall battery drain when the electromechanical arm is not moving,

17. Item of claim 3 that, upon sensing the control intention to open the gripper, introduces a 1 second delay, or some a delay of some other period of length that is adjustable, during which time the operator may end the input signal to abort the gripper open action, if is decided by the operator that this action was not intended.
